(19) United States
(12) Patent Application Publication
(10) Pub. No.: US 2010/0038188 A1
(43) Pub. Date: Feb. 18, 2010

(54) AIRCRAFT BRAKE ACTUATION MEASUREMENT UNIT

(75) Inventor: Eric D. Cahill, Troy, OH (US)

Correspondence Address: SNELL & WILMER L.L.P. (GOODRICH), ONE ARIZONA CENTER, 400 E. VAN BUREN STREET, PHOENIX, AZ, 85004-2202, US

(73) Assignee: GOODRICH CORPORATION, Charlotte, NC (US)

(21) Appl. No.: 12/442,657

(22) PCT Filed: Oct. 24, 2007
(86) PCT No.: PCT/US07/82374

§ 371 Date: Mar. 24, 2009

Related U.S. Application Data
(60) Provisional application No. 60/862,633, filed on Oct. 24, 2006.

(51) Int. Cl. F16D 66/00

(52) U.S. Cl. 188/1.11 E

(57) ABSTRACT

A compact aircraft brake actuation measurement unit (5) mountable between left and right brake pedals for measuring the position of each pedal. The unit (5) can generate a signal indicative of a position of a pedal that can be used to control a brake assembly. The unit (5) can be mounted to a floor, bulkhead, forward wall, or any other suitable surface of a cockpit. The unit (5) includes sensors (20; 22), such as linear variable transducers (LVDTs), connectable to the pedals for sensing the position of the pedals.

### RELATED APPLICATIONS

This application claims the benefit of U.S. Provisional Application No. 60/862,633 filed Oct. 24, 2006, which is hereby incorporated by reference.

### FIELD OF THE INVENTION

The invention herein described relates to aircraft brake systems and, more particularly, to actuation measurement systems for aircraft brakes.

### BACKGROUND OF THE INVENTION

Typical aircraft today rely on a large amount of onboard electronic and computer equipment for operation of critical systems, safety, navigation, etc. For most aircraft, the space required for electronic and computer equipment tends to be substantial, and the total volume of such equipment is roughly the same regardless of aircraft size. Accordingly, onboard space is at a premium, particularly in smaller aircraft. Space in and around the cockpit of an aircraft is particularly valuable.

### SUMMARY OF THE INVENTION

The present invention provides a compact aircraft brake actuation measurement unit mountable between left and right brake pedals for measuring the position of each pedal. The unit can generate a signal indicative of a position of a pedal that can be used to control a brake assembly. The unit can be mounted to a floor, bulkhead, forward wall, or any other suitable surface of a cockpit. The unit can include sensors, such as linear variable transducers (LVDTs), connectable to the pedals for sensing the position of the pedals.

Accordingly, a brake actuation measurement unit comprises a body, a first sensor supported by the body and having a plunger connectable to a first brake pedal, and a second sensor supported by the body and having a plunger connectable to a second brake pedal, wherein the first and the second sensor operate to measure respective positions of the first pedal and second pedal when connected thereto. At least one of the first sensor and second sensor can be a linear variable displacement transducer or a potentiometer, such as a conductive plastic potentiometer. The first and second sensors can include a pair of linear variable displacement transducers which can be removable individually from the unit. The unit can be mounted to a floor, bulkhead, or other surface of a cockpit of an aircraft.

In accordance with another aspect, an aircraft braking system includes a brake assembly operative to brake at least one wheel of an aircraft, and a brake actuation measurement unit as set forth above operative to provide a signal for actuating the brake assembly. The brake actuation measurement unit can generate a signal indicative of pedal position that can be used to actuate the brake assembly.

In accordance with another aspect, an aircraft braking system includes a brake assembly operative to brake at least one wheel of an aircraft, a first brake actuation measurement unit as set forth above associated with a first set of pedals, and a second brake actuation measurement unit as set above associated with a second set of pedals. Both the first unit and second unit are operative independently to provide a signal for actuating the brake assembly. The signal generated by at least one of the first and second units can be indicative of a position of a pedal operatively coupled to the respective unit.

Further features of the invention will become apparent from the following detailed description when considered in conjunction with the drawings.

### BRIEF DESCRIPTION OF THE DRAWINGS

FIG. 1 is a perspective view of an exemplary brake actuation measurement unit in accordance with the invention.

FIG. 2 is a side elevational view of the brake actuation measurement.

FIG. 3 is a cross-sectional view taken along the line A-A in FIG. 2.

FIG. 4 is a top view of the brake actuation measurement unit.

FIG. 5 is a rear elevational view of the brake actuation measurement unit.

FIG. 6 is a schematic diagram of an aircraft having a brake system including a first and second brake actuation measurement unit.

### DETAILED DESCRIPTION

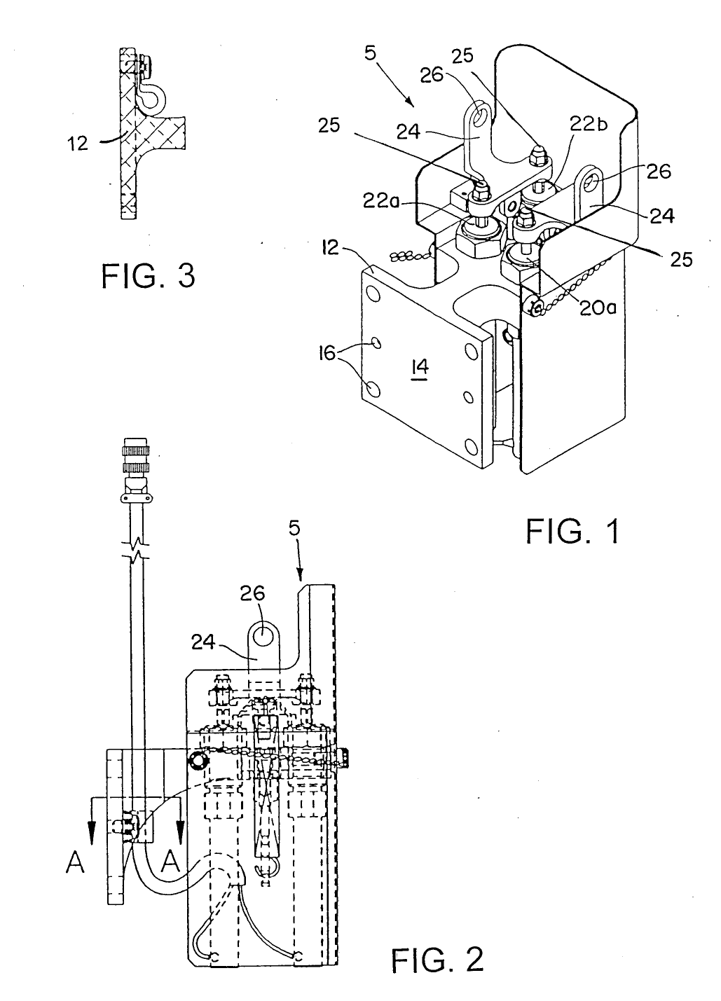

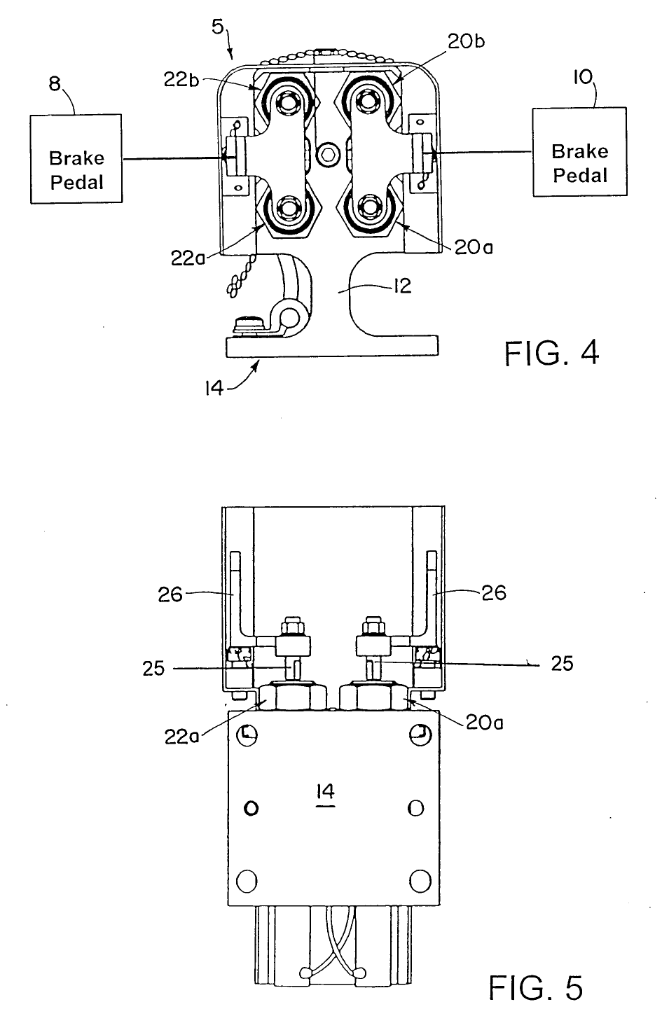

Referring now to the drawings in detail and initially to FIGS. 1-5, an exemplary brake actuation measurement unit in accordance with the invention is indicated generally by reference numeral 5. The unit 5 is a line replaceable unit (LRU) and is mountable to a surface of an aircraft, such as a floor or bulkhead of the aircraft, for example. As will be described, the unit 5 is connectable to a pair of brake pedals 8 and 10, shown schematically in FIG. 4, of either a pilot or co-pilot station of an aircraft and is configured to measure the position of each pedal connected thereto for providing a signal to a brake assembly of an aircraft for operation thereof.

The unit 5 includes a body 12 having a mounting surface 14. The mounting surface 14 has a plurality of mounting holes 16 through which fasteners, such as bolts, can be inserted for securing the unit 5 to a surface of a cockpit, such as a floor, bulkhead, forward wall, etc. Two pairs of sensors, which in the illustrated embodiment are pairs of linear variable displacement transducers (LVDTs) 20a, 20b and 22a and 22b but may be any suitable type of sensor such as a potentiometer for example, are supported by the body 12. Each pair of LVDTs 20a, 20b and 22a, 22b has associated therewith a bracket 24 for facilitating connection of a plunger 25 of each LVDT to a respective brake pedal.

Each bracket 24 is secured to a movable element (e.g., plunger 25) of each LVDT for movement therewith. A hole 26 at a distal end of each bracket 24 is connectable directly, or via a suitable linkage, to a respective brake pedal. Accordingly, motion of each pedal is independently transferred to a respective pair of LVDTs 20a, 20b and 22a, 22b. Preferably, the linkage connecting the respective brake pedals to the unit 5 minimizes interference with other functions of the pedals, such as a rudder control function, for example.

It will be appreciated that the unit 5 generates a signal that can be used to actuate a brake assembly associated with one or more wheels of an aircraft. In this regard, various algorithms can be used to compare the signals generated by each LVDT in a pair to ensure an accurate signal is output by the unit 5 to the brake assembly.

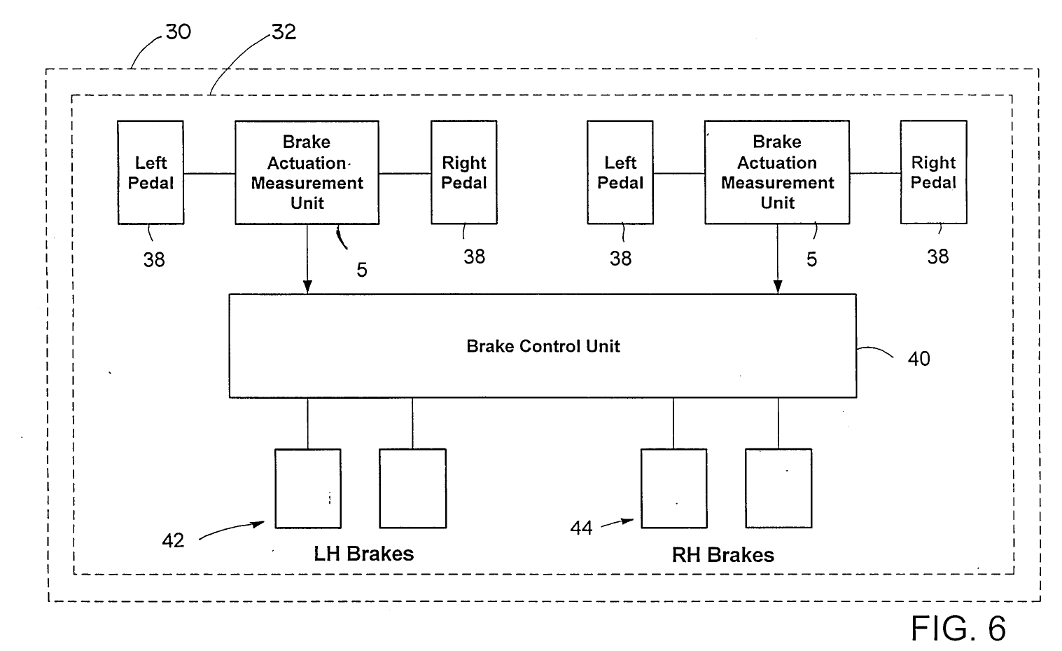

Turning to FIG. 6, an aircraft 30 is schematically illustrated including a brake system 32 having first and second brake actuation measurement units 5 in accordance with the invention. The brake actuation measurement units 5 are operatively coupled to respective pairs of brake pedals 38 operable by a pilot and copilot. The units 5 generate signals corresponding to the position of the pedals 38, as described above. The signals are sent to a brake control unit 40 that is connected to left and right hand brake assemblies 42 and 44 configured for braking respective wheels of the aircraft. The brake control unit 40 utilizes the signals generated by the units 5 to control actuation of the brake assemblies 42.

It will be appreciated that by providing separate single units 5 having LVDTs for both left and right pedals of each pair of pedals (e.g., pilot and copilot pedals) can reduce cost, size, weight, and the number of line replaceable units on the aircraft. As will be appreciated, the units 5 can be easily installed and provide a platform for an integral feel mechanism, such as for providing the same force feedback to both the pilot's and co-pilot's brake pedals, for example. Pedal return springs and pedal force springs can be associated with the units 5 and/or pedals 38 for providing force feedback to the pilot and/or copilot pedals either separately or integrally. Further, one or more of the LVDT's of a unit can be readily replaced without having to open a housing of the unit 5, or without removing the unit 5 from an aircraft. Accordingly, the unit 5 can decrease aircraft downtime.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A brake actuation measurement unit comprising:
a body;
a first sensor supported by the body and having a plunger connectable to a first brake pedal;
a second sensor supported by the body and having a plunger connectable to a second brake pedal;
wherein the first and the second sensor operate to measure respective positions of the first pedal and second pedal when connected thereto.

2. A brake actuation measurement unit as set forth in claim 1, wherein at least one of the first sensor and second sensor is a linear variable displacement transducer.

3. A brake actuation measurement unit as set forth in claim 2, wherein the linear variable displacement transducer is removable as a unit from the brake actuation measurement unit.

4. A brake actuation measurement unit as set forth in claim 1, wherein at least one of the first sensor and second sensor is a potentiometer.

5. A brake actuation measurement unit as set forth in claim 4, wherein the potentiometer is a conductive plastic potentiometer.

6. A brake actuation measurement unit as set forth in claim 1, wherein at least one of the first and second sensors includes a pair of linear variable displacement transducers.

7. A brake actuation measurement unit as set forth in claim 1, wherein the unit is mountable to a floor of a cockpit of an aircraft.

8. A brake actuation measurement unit as set forth in claim 1, wherein the unit is mountable to a bulkhead of an aircraft.

9. An aircraft braking system including a brake assembly operative to brake at least one wheel of an aircraft, and a brake actuation measurement unit as set forth in claim 1 operative to provide a signal for actuating the brake assembly.

10. An aircraft braking system as set forth in claim 9, wherein the brake actuation measurement unit generates a signal that can be used to actuate the brake assembly.

11. An aircraft braking system as set forth in claim 10, wherein the signal generated is indicative of a position of a pedal operatively coupled to the brake actuation measurement unit.

12. An aircraft braking system including a brake assembly operative to brake at least one wheel of an aircraft, a first brake actuation measurement unit as set forth in claim 1 associated with a first set of pedals, and a second brake actuation measurement unit as set forth in claim 1 associated with a second set of pedals, wherein both the first unit and second unit are operative independently to provide a signal for actuating the brake assembly.

13. An aircraft braking system as set forth in claim 12, wherein the signal generated by at least one of the first and second units is indicative of a position of a pedal operatively coupled to the respective unit.

14. An aircraft braking system as set forth in claim 13, wherein the unit is mountable between brake pedals of an aircraft.
